(19) United States
(12) Patent Application Publication
(10) Pub. No.: US 2004/0179877 A1
(43) Pub. Date: Sep. 16, 2004

(54) [AUTOMATIC DOCUMENT FEEDING DEVICE FOR SCANNING APPARATUS]

(76) Inventors: Yin-Chun Huang, Hsinchu (TW); Shu-Ya Chiang, Taichung (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/604,544

(22) Filed: Jul. 30, 2003

(30) Foreign Application Priority Data
Oct. 24, 2002 (TW) 91216995

(51) Int. Cl. G03G 15/00

(52) U.S. Cl. 399/367

(57) ABSTRACT

In a scanning apparatus including a scanning platform, an automatic document feeding device is mounted on the scanning platform to feed a document sheet to be scanned over the scanning platform. The automatic document feeding device includes an assembly of conveying rollers that are arranged along a sheet conveyance path terminating respectively in a sheet intake end and a sheet release end. The sheet conveyance path passes over a scanning window of the automatic document feeding device through which the document sheet is scanned. At least one of the sheet intake end or the sheet release end is located in proximity of an area of the scanning platform that thereby receives document sheets to be scanned or document sheets the scanning of which is completed.

### CROSS REFERENCE TO RELATED APPLICATIONS

This application claims the priority benefit of Taiwan application serial no. 91216995, filed Oct. 24, 2002.

### BACKGROUND OF INVENTION

1. Field of the Invention

The invention relates generally to an automatic document feeding device and, more particularly, to an automatic document feeding device for a scanning apparatus.

2. Description of the Related Art

Current scanning apparatuses increasingly become more popular as their commercial prices are substantially reduced and their performances enhanced. More particularly, the scanning apparatus recently developed is capable of scanning larger document sheets with higher image resolution via the use of an IEEE 1394 transmission interface. A scanning apparatus can be generally divided into several types such as a handheld scanning apparatus, a sheet feed scanning apparatus, a flatbed scanning apparatus, overhead scanning apparatus, and a positive/negative scanning apparatus.

Conventionally, the mount of an automatic document feeding device in the scanning apparatus allows to increase the efficiency of the processing of the document sheet. The automatic document feeding device is usually assembled on the scanning platform or inside the upper cover of the flatbed scanning apparatus.

Referring to FIG. 1, a schematic view illustrates an automatic document feeding device known in the prior art. As illustrated, the automatic document feeding device 100, mounted on a scanning apparatus 200, conventionally comprises a sheet intake tray 102, a sheet conveyance mechanism 104, and a sheet release tray 108. The sheet conveyance mechanism 104 includes an assembly of rollers 106 (formed of active rollers 106a and idle rollers 106b) that convey the document sheet 110 along an L-shaped sheet conveyance path (shown in dashed line). The fed document sheet 110 is typically scanned by a scanning module 210 mounted in the scanning apparatus 200. As illustrated, the sheet intake tray 102 and the sheet release tray 108 terminate the L-shaped sheet conveyance path. The sheet release tray 108 is located over the scanning platform 220 and adjacent to a sheet release end of the sheet conveyance mechanism 104 to receive scanned document sheets. The size of the sheet release tray 108 covers the surface area of the scanning platform 220. The sheet intake tray 102 is placed adjacent to a sheet intake end of the sheet conveyance mechanism 104, where are placed a document sheet 110 to be scanned.

In FIG. 2 where is illustrated another automatic document feeder known in the prior art, the sheet intake tray 102 and the sheet release tray 108 are arranged parallel to each other, the sheet release tray 108 being adjacently mounted on the scanning platform 220 at the side of the sheet release end of the sheet conveyance path, approximately U-shaped.

The above assembly of the sheet intake/release trays increases the production cost and the size of the automatic document feeding device. Furthermore, an adequate design of the sheet intake/release trays should envisage the accommodation of their lengths to a dimension that allows a convenient carrying of the automatic document feeding device.

### SUMMARY OF INVENTION

An aspect of the invention is therefore to provide an automatic document feeding device for a scanning apparatus that allows the use of the scanning platform as sheet intake and release areas for document sheets to be scanned and document sheets the scanning of which has been completed.

Another aspect of the invention is to provide a scanning apparatus that uses the scanning platform of the scanning apparatus as sheet intake and release areas for receiving document sheets to be scanned and document sheets the scanning of which has been completed.

To accomplish the above and other objectives, an automatic document feeding device is mounted on a scanning platform of a scanning apparatus to feed a document sheet to be scanned over the scanning platform. The automatic document feeding device comprises an assembly of conveying rollers that are arranged along a sheet conveyance path terminating respectively in a sheet intake end and a sheet release end. The document sheet to be scanned in inserted through the sheet intake end, is conveyed along the sheet conveyance path, and is released through the sheet release end. The sheet conveyance path passes over a scanning window of the automatic document feeding device through which the document sheet is scanned. The sheet intake end and the sheet release end are respectively placed in proximity over areas of the scanning platform that thereby receive document sheets to be scanned and document sheets the scanning of which has been completed.

According to one embodiment of the invention, the scanning apparatus further comprises a casing having an opening on which is mounted the scanning platform. A scanning module is mounted to a linear guiding mechanism inside the casing. The scanning module is driven in motion by means of a driving device including a motor and a transmission belt.

According to a variant embodiment, the automatic document feeding device may further include a sheet intake tray or a sheet release tray.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating an automatic document feeding device known in the prior art.

FIG. 2 is a schematic view illustrating another automatic document feeding device known in the prior art.

FIG. 3 is a schematic view illustrating a scanning apparatus provided with an automatic document feeding device according to an embodiment of the invention.

FIG. 4 is a schematic view illustrating a scanning apparatus provided with an automatic document feeding device according to another embodiment of the invention.

FIG. 5 is a schematic view illustrating a scanning apparatus provided with an automatic document feeding device according to another variant embodiment of the invention.

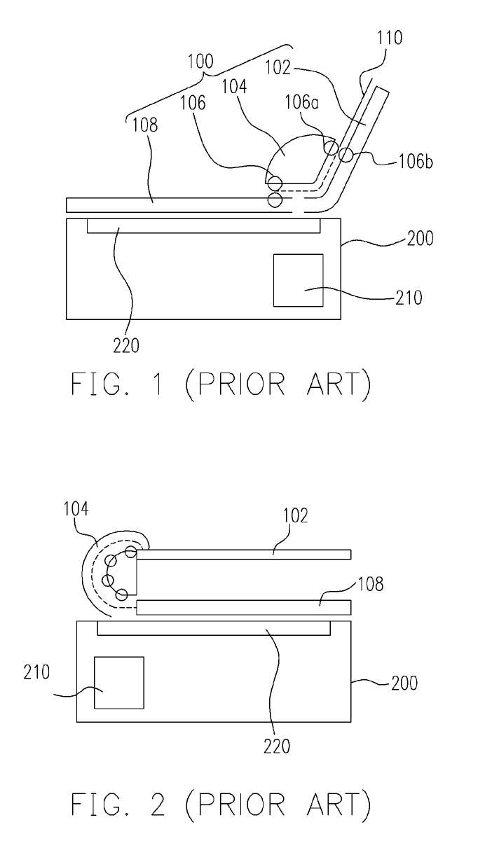

### DETAILED DESCRIPTION

The following detailed description of the embodiments and examples of the present invention with reference to the accompanying drawings is only illustrative and not limiting. Furthermore, wherever possible in the description, the same reference symbols will refer to similar elements and parts unless otherwise illustrated in the drawings.

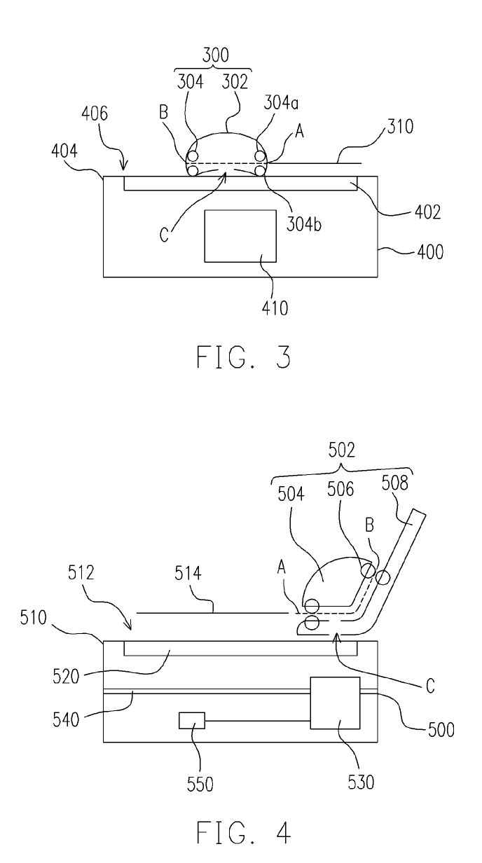

Referring to FIG. 3, a schematic view illustrates a scanning apparatus provided with an automatic document feeding device according to an embodiment of the invention. As illustrated, the scanning apparatus 400 comprises an automatic document feeding device 300 that is mounted over a scanning platform 402. The automatic document feeding device 300 comprises a sheet conveyance mechanism 302 in which an assembly of conveying rollers 304 (formed of active rollers 304a and idle rollers 304b) is arranged along a sheet conveyance path (represented in dashed line) terminating in a sheet intake end A and a sheet release end B. A portion of the sheet conveyance path is approximately parallel to the scanning platform 402. The scanning platform 402 is mounted on an opening 406 of the casing 404 of the scanning apparatus 400.

Preferably, the sheet intake end A and the sheet release end B of this embodiment are respectively located in proximity of the scanning platform 402. Correspondingly adjacent areas of the scanning platform 402 are therefore advantageously used as sheet receiving areas respectively for to-be-scanned document sheets 310 that are fed through the sheet intake end A, and for scanned document sheets that are released through the sheet release end B. No sheet receiving trays are therefore needed in the scanning apparatus 400.

As illustrated, the automatic document feeding device 300 is provided with a scanning window C that is adjacent to the sheet conveyance path and faces the scanning platform 402. Inside the scanning apparatus 400 is further mounted a scanning module 410 under the scanning platform 402. The scanning module 410 may be, for example, a contact type scanning module constructed from a contact image sensor, or a non-contact type scanning module constructed from a charge coupled device (not shown). In the latter construction, the non-contact type scanning module comprises a light source, an assembly of reflective mirrors, and an objective lens (not shown). As it is known in the art, the light source emits a light on the document being scanned, which produces an image light that travels through the reflective mirrors, and through the objective lens forms an image on the charge coupled device.

Referring to FIG. 4, a schematic view illustrates a scanning apparatus provided with an automatic document feeding device according to another embodiment of the invention. The scanning apparatus 500 comprises a casing 510, a scanning platform 520, a scanning module 530, a linear guiding mechanism 540, and a driving device 550. The casing 510 includes an opening 512 on which is mounted the scanning platform 520, the scanning module 530 being assembled in the casing 510. The linear guiding mechanism 540 may be, for example, a rod mounted in the casing 510 and to which is assembled the scanning module 530. The driving device 550 is, for example, a motor, which is connected to the scanning module 530 via, for example, a belt transmission assembly.

The automatic document feeding device 502 is mounted over the scanning platform 520, and comprises a sheet conveyance mechanism 504 and a sheet release tray 508. The sheet conveyance mechanism 504 includes an assembly of conveying rollers 506 that are arranged along a sheet conveyance path (shown in dashed line). The sheet conveyance path terminates respectively in a sheet intake end A at one side over the scanning platform 520, and a sheet release end B at another side adjacent to the sheet release tray 508. At the sheet intake end A, an adjacent underlying area of the scanning platform 520 is therefore used as a sheet receiving area from which a document sheet 514 is taken and inserted through the sheet intake end A of the automatic document feeding device 502 to be scanned. Once it has been scanned, the document sheet 514 is released through the sheet release end B on the sheet release tray 508. As a result, no document sheet tray is needed at the side of the sheet intake end A. A side of the automatic document feeding device 502 facing the scanning platform 520 further includes a scanning window C. It will be understood that the sheet intake end and the sheet release end may be interchanged. Accordingly, the transparent platform 520 would become a sheet receiving area for scanned document sheets released through the sheet release end B, while the tray 508 is mounted adjacent to the sheet intake end A to receive document sheets to be scanned.

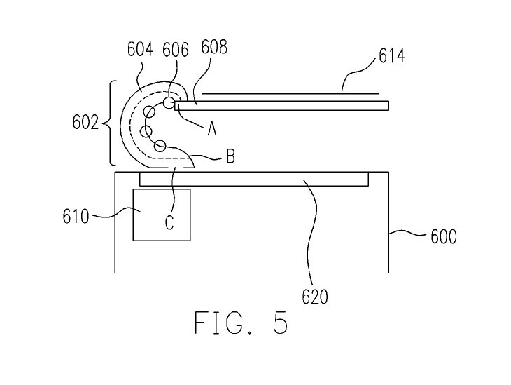

Referring to FIG. 5, a schematic view illustrates a scanning apparatus provided with an automatic document feeding device according to another variant embodiment of the invention. The scanning apparatus 600 comprises a contact type scanning module 610 that performs scanning of a document sheet 614. The automatic document feeding device 602 is mounted over the scanning platform 620 and comprises a sheet conveyance mechanism 604 and a sheet intake tray 608 where one or more document sheet 614 to be scanned is placed. The sheet conveyance mechanism 604 comprises an assembly of conveying rollers 606 that are arranged along a sheet conveyance path illustrated in dashed line. The automatic document feeding device 602 further includes a scanning window C that faces the scanning platform 620 of the scanning apparatus 600.

The sheet conveyance path terminates respectively in a sheet intake end A, adjacent to the sheet intake tray 608, and a sheet release end B in proximity of the scanning platform 620. An area of the scanning platform 620 adjacent to the sheet release end B is therefore used as a sheet receiving area for scanned document sheets that are released through the sheet release end B.

It should be noticed that the automatic document feeding device of the invention as described in the above various embodiments may be adapted to different types of scanning apparatus to advantageously perform automatic feeding of document sheets to be scanned.

As described above, the invention therefore includes at least the following advantages.

1. The provision of the automatic document feeding device allows the use of the scanning platform as a sheet receiving area for to-be-scanned document sheets and/or document sheets the scanning of which has been accomplished.

2. The automatic document feeding device has a reduced size, and is more economical to fabricate.

It should be apparent to those skilled in the art that other structures that are obtained from various modifications and variations of different parts of the above-described structure of the invention would be possible without departing from the scope and spirit of the invention as illustrated herein. Therefore, the above description of embodiments and examples only illustrates specific ways of making and performing the invention that, consequently, should cover variations and modifications thereof, provided they fall within the inventive concepts as defined in the following claims.

1. An automatic document feeding device, being mounted over a scanning platform of a scanning apparatus to feed a document sheet to be scanned over the scanning platform, the automatic document feeding device comprising an assembly of conveying rollers that are arranged along a sheet conveyance path terminating respectively in a sheet intake end and a sheet release end, the sheet conveyance path passing over a scanning window of the automatic document feeding device through which the document sheet is scanned, wherein at least one of the sheet intake end or the sheet release end is located in proximity of an area of the scanning platform that receive document sheets to be scanned or document sheets the scanning of which is completed.

2. The automatic document feeding device of claim 1, further including a sheet intake tray placed adjacent to the sheet intake end.

3. The automatic document feeding device of claim 1, further including a sheet release tray placed adjacent to the sheet release end.

4. A scanning apparatus, comprising:
a scanning platform; and
an automatic document feeding device, mounted on the scanning platform, the automatic document feeding device including an assembly of conveying rollers that are arranged along a sheet conveyance path terminating respectively in a sheet intake end and a sheet release end, the sheet conveyance path passing over a scanning window of the automatic document feeding device through which the document sheet is scanned, wherein at least one of the sheet intake end or the sheet release end is located in proximity of an area of the scanning platform that thereby receives document sheets to be scanned or document sheets the scanning of which is completed.

5. The scanning apparatus of claim 4, further comprising:
a casing, including an opening on which is mounted the scanning platform; and
a scanning module, mounted inside the casing to scan the document sheet through the scanning platform and the scanning window.

6. The scanning apparatus of claim 5, wherein the scanning module is a contact type scanning module.

7. The scanning apparatus of claim 5, wherein the scanning module is a non-contact type scanning module.

8. The scanning apparatus of claim 5, further including:
a linear guiding mechanism, mounted in the casing and connected to the scanning module; and
a driving device, mounted in the casing and connecting the scanning module to the linear guiding mechanism.

9. The scanning apparatus of claim 8, wherein the linear guiding mechanism is a shaft.

10. The scanning apparatus of claim 8, wherein the driving device further includes:
a motor, mounted in the casing; and
a transmission belt, connecting the motor to the scanning module.

11. The scanning apparatus of claim 8, wherein the scanning module is a contact type scanning module.

12. The scanning apparatus of claim 8, wherein the scanning module is a non-contact scanning module.

13. The scanning apparatus of claim 4, further including a sheet intake tray placed adjacent to the sheet intake end.

14. The scanning apparatus of claim 4, further including a sheet release tray placed adjacent to the sheet release end.
